(19) United States
(12) Patent Application Publication
(10) Pub. No.: US 2005/0261899 A1
(43) Pub. Date: Nov. 24, 2005

(54) Methods of improving capacity for voice users in a communication network

(76) Inventors: Stefan Brueck, Nuremberg (DE); Stefan Klein, Erlangen (DE)

Correspondence Address: HARNESS, DICKEY & PIERCE, P.L.C., P.O. Box 8910, Reston, VA, 20195, US

(21) Appl. No.: 10/848,009

(22) Filed: May 19, 2004

(51) Int. Cl. G10L 19/12

(52) U.S. Cl. 704/221

(57) ABSTRACT

In a method for improving capacity for voice users in a communication network and/or a method of avoiding channelization code starvation in the downlink when establishing a voice call with one or more users in the wireless network, two sets of channelization codes may be defined, each adapted for use with a corresponding first spreading factor and second spreading factor. One of the first and second AMR codec sets may be selected based on a comparison of a given number of available channelization codes for a voice call to a threshold, so as to encode voice data for transmission over an air interface.

### BACKGROUND OF THE INVENTION

1. Field of the Invention

The present invention is generally related to methods for improving network capacity for voice users in a wireless communication network.

2. Description of the Related Art

As mobile operators seek to grow the subscriber base in a cost-effective manner, improved network capacity and high speech quality are in greater demand than ever before. A challenge facing network operators is how to provide better coverage to more remote areas at substantial distances from main cities, where network coverage is typically unreliable or nonexistent, while remaining cost-effectively.

The Adaptive Multi-Rate (AMR) speech codec may assist network operators with meeting this challenge. AMR may enable better speech quality and increase the capacity of a given network. The AMR speech codec and associated voice services are employed in Third Generation Partnership Project (3GPP)-based based radio systems, GSM and Wideband CDMA (WCDMA) radio networks. The AMR codec supports eight different speech codec modes with bit rates ranging from 4.75 kbps to 12.2 kbps.

In genera, AMR rate adaptation employs a control loop. The bit rate in AMR may be dynamically controlled by the radio network based on the link conditions or based on the system load. For example, an AMR speech codec may reside in the user equipment (UE) and/or in the core network (CN). The radio network controller (RNC) of an access network such as a UMTS Terrestrial Radio Access Network (UTRAN), via a suitable Iu protocol, may transmit a downlink AMR mode command to the core network.

In response, the core network may transmit downlink speech data with AMR mode information to the RNC, and subsequently to the base transceiver station (BTS) and served UEs. The RNC, referred to as the serving RNC (SRNC) may issue an uplink AMR code command to the UE via the BTS, and receive uplink speech data with AMR mode information in response to the commanded AMR mode.

In UMTS, which uses WCDMA, every user may be allocated a channelization code in the downlink direction. All channelization codes in UMTS are orthogonal in order to assure successful data separation to the UE. The channelization codes may be embodied as Walsh Hadamard codes of length from 4 to 256, for example. The channelization code being used for a specific AMR codec set depends on the selected AMR codecs. All codecs within a given AMR codec use the same channelization code length.

FIG. 1 illustrates a channelization code tree. In order to generate channelization codes, certain generation rules are observed in UMTS. FIG. 1 illustrates an exemplary channelization code tree to describe these rules. For example, in starting from code C_{1,0}=0 two child codes C_{x+1,2y} and C_{x+1,2y+1} can be derived from the parent code C_{x,y}. The child code C_{x+1,2y} may repeat the parent code twice. The other child code C_{x+1,2y+1} may repeat the parent code twice, but inverts the second sequence. This results in a code tree as shown in FIG. 1.

The codes contained in each layer of the code tree may be mutual or orthogonal. In addition, any two codes from different layers of the code tree are also orthogonal, except when one code is the parent or child of the other code. In order to preserve orthogonality, the use of Orthogonal Variable Spreading Factor (OVSF) codes may have two restrictions, as illustrated by the following example. First, if code C_{8,0} is in use, parent codes C_{4,0} and C_{2,0} cannot be used; and second, if code C_{2,0} is in use, the child codes C_{4,0}, C_{4,1}, C_{8,0}, C_{8,1}, C_{8,2} and C_{8,3} may not be used.

Currently, for the highest bit-rate voice codec (AMR 12.2 kbps), a spreading factor of 128 is recommended (e.g., 3GPP TS 34.108 recommends to use length 128 for 12.2 kbps in downlink direction). Considering that some channelization codes may be required for common control channels, about 120 channelization codes may be available in a given cell. When an UE is in soft handover state (e.g., in soft handover, the radio links are added and removed in a way that the UE always keep at least one radio link to the UTRAN), the UE allocates spreading codes in multiple cells. In constellations where several UEs are in a soft handover state, cell capacity may be limited by channelization code blocking (due to the absence of available channelization codes, known as ‘channelization code starvation’). From an interference perspective, however, more users can be added to the cell.

Some consideration has been made to address the above cell capacity limitation, due to insufficient available channelization codes, with introduction of secondary scrambling codes in a given cell. However, with a secondary scrambling code, an additional channelization code tree (i.e., in addition to the code tree of FIG. 1), would need to be available to serve additional users. Further, and due primarily to the limited orthogonality of the scrambling codes, a UE using another scrambling code could add substantially more interference to all UEs in the cell, as compared to UEs which use the same scrambling code. Consequently, the introduction of a secondary scrambling code in a cell does not provide the desired capacity enhancement in UMTS and other similarly-situated WCDMA wireless communication networks.

### SUMMARY OF THE INVENTION

An exemplary embodiment of the present invention is directed to a method of improving capacity for voice users in a communication network. A first AMR codec set adapted for use with a first spreading factor may be defined, and a second AMR codec set adapted for use with a second spreading factor may be defined. One of the first and second AMR codec sets may be selected based on a given number of available spreading codes for coding voice data for transmission over an air interface. Another exemplary embodiment of the present invention is directed to a method of avoiding channelization code starvation in the downlink when establishing a voice call with one or more users in a wireless network. A given number of available channelization codes for a voice call may be compared against a threshold. Based on the comparison, a given AMR codec set may be selected for use for the call.

### BRIEF DESCRIPTION OF THE DRAWINGS

The exemplary embodiments of the present invention will become more fully understood from the detailed description given herein below and the accompanying drawings, wherein like elements are represented by like reference numerals, which are given by way of illustration only and thus are not limitative of the exemplary embodiments of the present invention.

FIG. 1 illustrates a channelization code tree.

FIG. 2 is a flow diagram for describing a method of improving capacity for voice users in accordance with an exemplary embodiment of the present invention.

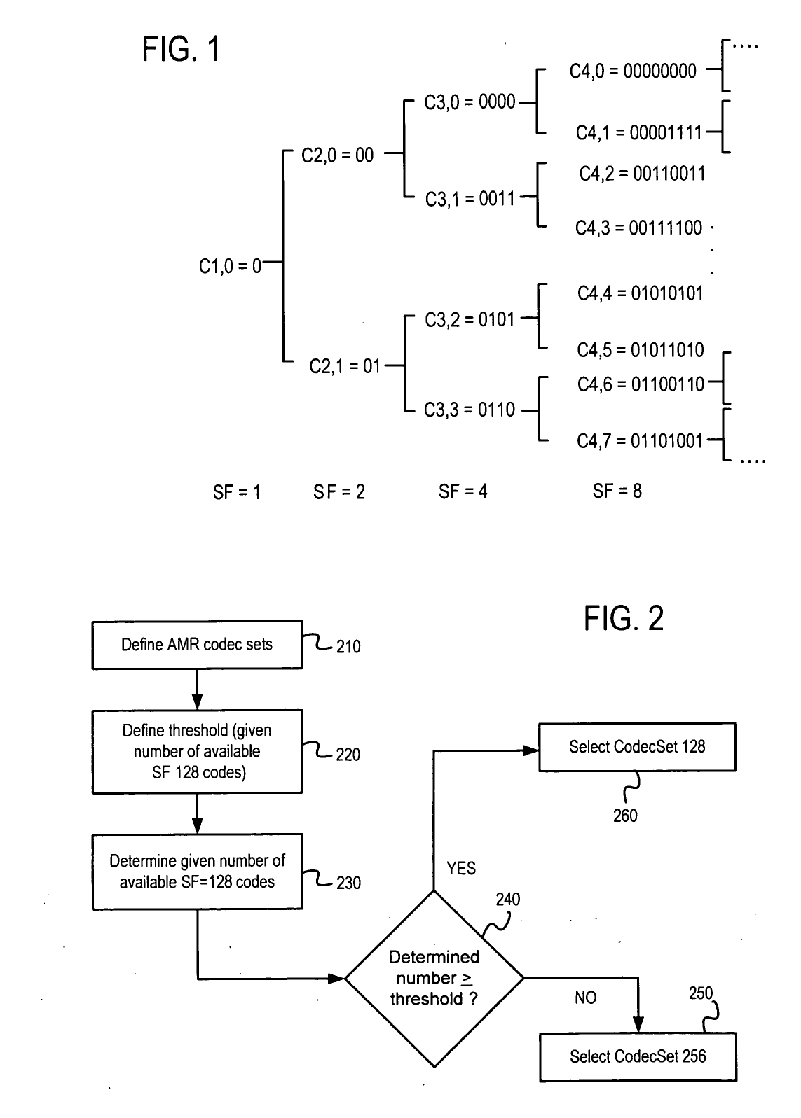

### DETAILED DESCRIPTION OF THE EXEMPLARY EMBODIMENTS

Although the principles of the exemplary embodiments of the present invention may be particularly well-suited for wireless communication systems based on WCDMA technologies, standards and techniques, and may be described in this exemplary context, it should be noted that the exemplary embodiments shown and described herein are meant to be illustrative only and not limiting in any way. For example, the exemplary embodiments of the present invention are also applicable to other radio networks and/or developing wireless communication systems such as developing fourth generation (4G) wireless communication systems. As such, various modifications will be apparent to those skilled in the art for application to other wireless communication systems and are contemplated by the teachings herein.

Where used below, the term ‘user equipment’ (UE) may be considered synonymous to a mobile station, mobile, mobile user, subscriber, user, remote station, access terminal, etc., and may describe a remote user of wireless resources in a wireless communication network. The term ‘NodeB’ may be considered synonymous to a base station or base transceiver station (BTS), and may describe equipment that provides data and/or voice connectivity between a network and one or more UEs. A system or network (such as an access network) may include one or more base stations.

As used below, the phrase ‘AMR codec set’ may refer to a given set of AMR codecs using the same channelization code length to encode one or more frames carrying voice service information and/or related control information in the downlink to one or more users. A concept of the AMR codec that a arbitrary set of codec modes (out of the eight modes) can be applied in a mobile communication network. A given AMR codec set may be negotiated during call setup between the network and UE. Typically, these codec sets are defined by the network operator.

In general, exemplary embodiments of the present invention may be directed to methods of improving capacity for voice users in a communication network. For example, a first AMR codec set adapted for use with a first spreading factor may be defined, and a second AMR codec set adapted for use with a second spreading factor may be defined. One of the first set and second AMR coded sets may be selected based on a given number of available or free channelization codes, so as to provide voice/data services for transmission over an air interface. A given AMR codec set is associated with one channelization code length.

However, in order to place the exemplary methodologies described hereafter in context, the inventors provide a general overview of the AMR speech codec. The AMR speech coder consists of the multi-rate speech coder, a source controlled rate scheme including a voice activity detector and a comfort noise generation system, and an error concealment mechanism to combat the effects of transmission errors and lost packets.

The multi-rate speech coder may be embodied as a single integrated speech codec with eight source rates from 4.75 kbps to at least 12.2 kbps, and a low rate background noise encoding mode. The speech coder may be capable of switching its bit-rate every 20 ms speech frame upon command. Table 1 illustrates the eight codec modes.

TABLE 1
Source codec bit-rates for the AMR codec.

| Codec mode | Source codec bit-rate | |
|---|---|---|
| AMR_12.20 | 12.20 | kbps (GSM EFR) |
| AMR_10.20 | 10.20 | kbps |
| AMR_7.95 | 7.95 | kbps |
| AMR_7.40 | 7.40 | kbps (IS-641) |
| AMR_6.70 | 6.70 | kbps (PDC-EFR) |
| AMR_5.90 | 5.90 | kbps |
| AMR_5.15 | 5.15 | kbps |
| AMR_4.75 | 4.75 | kbps |

Overview of the AMR Conceit

Accordingly, AMR is a Multi-Rate speech codec with the ability to operate at eight (8) distinct bit rates or modes: 12.2, 10.2, 7.95, 7.4, 6.7, 5.9, 5.15 or 4.75 kbps. For compatibility with legacy systems, the 12.2 and 7.4 modes are compatible versions of the GSM EFR and IS-136 EFR speech codecs, as shown in Table 1. In addition, the AMR speech codec was designed to allow seamless switching on a frame by frame basis between the different modes.

The AMR speech codec may provide a high quality speech service with the additional flexibility of the Multi-Rate approach allowing a gentle trade-off between quality and capacity as a function of the network load. This flexibility may be equally applicable to 2G and 3G networks, and may also be applicable to developing 4G networks.

The multi-rate concept behind AMR may be adaptable not only in terms of an ability to respond to changing radio and traffic conditions, but also to be customized to the specific needs of network operators. This may provide additional robustness for the AMR codec so as to extend the coverage in marginal signal conditions, or to improve the capacity by using a tighter frequency re-use, assuming high AMR mobile station (MS) penetration.

Accordingly, the AMR speech codec having been introduced, exemplary methodologies for improving capacity and/or avoiding channelization code starvation for voice users in WCDMA radio networks employing AMR may now be described. As discussed above, the AMR voice codec deploys eight (8) different compression factors (i.e., voice or source codec modes) which results in net data rates of 4.75, 5.15, 5.9, 6.7, 7.4, 7.95, 10.2 and 12.2 kbps that may be transferred across an air interface such as a UMTS air interface, for example. In general the codec modes with lower compression factor (higher net data rates such as 5.9 kbps and above) provide a higher voice quality, while the codec modes with a lower net rate (less than 5.9 kbps) may allow additional redundancy to be added to the signal to be transmitted in order to improve receiver performance. This may be especially helpful in case of high load situations in the cell.

In general, the exemplary methodologies may define two different AMR codec sets. The first set may be adapted for use with a spreading factor of 128, and the second set may be adapted for use with a spreading factor of 256. The controlling or serving RNC (SRNC) may select one of the AMR codec sets based on a given number of available or free channelization codes. For example, if there are sufficient channelization codes available for use, the SRNC may allocate channelization codes with a SF=128. If the number of available codes is limited (i.e., where there is a high load situation in a cell), the RNC may allocate channelization codes adapted for use with a SF=256. The AMR codec sets are identical for uplink and downlink, although in the uplink, code blocking is not an issue since each UE has its own channelization code tree.

For the higher codec rates (such as net bit rates≧5.9 kbps, for example), a spreading factor SF=128 is recommended, but for the lower codec rates (such as net bit rates<5.9 kbps, for example), a spreading factor of 256 may be deployed, although it is within the skill of the art to deploy a spreading factor other than SF=256 for the lower codec rates. The higher spreading factor may enable the network to support more voice users in a given cell, because 256 channelization codes of length 256 are available.

FIG. 2 is a flow diagram for describing a method of improving capacity for voice users in accordance with an exemplary embodiment of the present invention. Referring to FIG. 2, an operator may define two codec sets, CodecSet128 and CodecSet256 (210). Additionally, the operator may define a threshold (220) that may be referred to as ‘NUM_FREE_{—}128_SPREADING_CODES’, i.e., the number of available SF128 codes, as a threshold criteria to select one of the codec sets, CodecSet128 and CodecSet256. Thus, the AMR codec sets and the threshold are tunable by the operator via an Operation Maintenance and Center (OMC-U) at the RNC. OMC-Us are configured for use on UMTS networks for assisting network operators to rapidly deploy UMTS networks by greatly simplifying fault, performance and configuration management as well as other key OMC-U functions. Thus, the RNC may keep track of the available channelization codes and the threshold.

Accordingly, if the RNC establishes an AMR voice call, the RNC may determine the number of available 128 spreading codes (230). For example, since the RNC manages the channelization codes, the RNC knows how many codes are occupied, and thus, how many channelization codes are free or available. If the pool of available SF=128 channelization codes is in relatively short supply (output of 240 is ‘NO), as in the case of a high load situation in a cell, the RNC selects CodecSet256 (250), otherwise CodecSet128 may be chosen (260).

Another exemplary embodiment may be directed to a method of avoiding channelization code starvation in the downlink when establishing a voice call with one or more users in a wireless network. The method is similar to that described with respect to FIG. 2. In general, a given number of available channelization codes for a voice call that are known at the RNC may be compared against a threshold such as described above, and a given AMR codec set may be selected to use for the call based on the comparison. Each selected AMR codec set is associated with a certain spreading factor (SF=128, SF=256) as described above.

Further, another exemplary embodiment may be directed to a method of transmission based on the above principles. For example, voice services which may be transmitted to users of the network may be encoded using one of the first and second AMR codec sets that are selected as described in FIG. 2, for example. Alternatively, another AMR codec set associated with a larger spreading factor may be chosen to avoid channelization code starvation in the downlink. For example, 3GPP also defines Wideband-AMR, which uses net data rates in excess of 12.2 kbps. The associated spreading factors in the downlink direction will thus be reduced for data rates higher than 12.2 kbps. The exemplary embodiments are thus applicable to AMR codec sets with net data rates in excess of 12.2 kbps and/or an AMR codec set at a spreading factor other than 128 and/or 256.

The exemplary methodologies for improving capacity (and/or avoiding channelization code starvation) in the downlink for voice users may offer several benefits. The risk of blocking situations for voice users, due to downlink channelization code starvation, may be reduced with application of the exemplary methodologies described herein. Code starvation problems may become especially evident if future capacity enhancements (such as intelligent antennas, for example) permit the support of additional users from an interference perspective.

Thus, the exemplary methodologies described herein may facilitate the improvement of voice capacity in a WCDMA system such as a UMTS network, for example. Further, the potential capacity increase offered by the exemplary embodiments may be substantially higher than the capacity increase achievable with the introduction of an additional code tree of scrambling codes, since the limited orthogonality of the additional scrambling codes may add substantially more interference to all UEs in the cell, thereby offsetting potential gains in capacity.

The exemplary embodiments of the present invention being thus described, it will be obvious that the same may be varied in many ways. For example, the logical blocks in FIG. 2 may be implemented in hardware and/or software. The hardware/software implementations may include a combination of processor(s) and article(s) of manufacture. The article(s) of manufacture may further include storage media, computer-readable media having code portions thereon that are read by a processor to perform the method, and executable computer program(s). The executable computer program(s) may include instructions to perform the described operations and the method. The computer executable(s) may also be provided as part of externally supplied propagated signals. Such variations are not to be regarded as a departure from the scope of the exemplary embodiments of the present invention, and all such modifications as would be obvious to one skilled in the art are intended to be included within the scope of the following claims.

1. A method of improving capacity for voice users in a communication network, comprising:
defining a first Adaptive Multi-rate (AMR) codec set adapted for use with a first spreading factor;
defining a second AMR codec set adapted for use with a second spreading factor; and
selecting either the first AMR codec set or the second AMR codec set for coding voice data for transmission over an air interface based on a given number of available channelization codes.

2. The method of claim 1, wherein selecting includes comparing the given number of available spreading codes against a threshold.

3. The method of claim 2, wherein selecting further includes selecting the first AMR codec set if the given number of available spreading codes exceeds the threshold.

4. The method of claim 2, wherein selecting further includes selecting the second AMR codec set if the given number of available spreading codes is less than or equal to the threshold.

5. The method of claim 1, wherein the selected AMR codec set is configured to provide voice services to one or more users in the network at net data rates between about 4.75 to in excess of 12.2 kilobits per second (kbps).

6. The method of claim 1, wherein the first AMR codec set deploys a spreading factor of 128.

7. The method of claim 1, wherein the first AMR codec set deploys a spreading factor of 128 to support AMR codec modes generating net data rates for voice services in a range of at least about 5.90 to at least 12.2 kbps.

8. The method of claim 1, wherein the second AMR codec set deploys a spreading factor of 256.

9. The method of claim 1, wherein the second AMR codec set deploys a spreading factor of 256 to support AMR codec modes generating net data rates for voice services in a range from about 4.75 to 5.90 kbps.

10. A method of avoiding channelization code starvation in the downlink when establishing a voice call with one or more users in a wireless network, comprising:
comparing a given number of channelization codes that are available for the voice call to a threshold, and
selecting a given AMR codec set to use for the call based on the comparison.

11. The method of claim 10, wherein the selected AMR codec set enables voice services to be provided to one or more users in the network at net data rates between about 4.75 to in excess of 12.2 kilobits per second (kbps).

12. The method of claim 10, wherein selecting includes selecting one of a first AMR codec set and a second AMR codec set based on the comparison.

13. The method of claim 12, wherein selecting includes selecting the first set if the given number of available spreading codes exceeds the threshold.

14. The method of claim 12, wherein selecting further includes selecting the second set if the given number of available spreading codes is less than or equal to the threshold.

15. The method of claim 12, wherein the first AMR codec set deploys a spreading factor of 128.

16. The method of claim 12, wherein the first AMR codec set deploys a spreading factor of 128 to support AMR codec modes generating net data rates for voice services in a range of about 5.90 to at least about 12.2 kbps.

17. The method of claim 12, wherein the second AMR codec set deploys a spreading factor of 256.

18. The method of claim 12, wherein the second AMR codec set deploys a spreading factor of 256 to support AMR codec modes generating net data rates for voice services in a rage from about 4.75 to 5.90 kbps.

19. In a wireless communication network, a method of transmitting voice services to users of the network in which voice services to be transmitted are encoded using the first or second AMR codec sets that are selected in accordance with the method of claim 1.

20. In a wireless communication network, a method of transmitting voice services to users of the network in which voice services to be transmitted are encoded using a given set of channelization codes that are selected in accordance with the method of claim 10.
